(19) United States
(12) Patent Application Publication
(10) Pub. No.: US 2021/0166481 A1
(43) Pub. Date: Jun. 3, 2021

(54) INTELLIGENT VIRTUAL OBJECT IN AN AUGMENTED REALITY ENVIRONMENT INTERACTIVELY RESPONDING TO AMBIENT ENVIRONMENTAL CHANGES

(71) Applicant: Zyetric Enterprise Limited, Kowloon (HK)

(72) Inventors: Pak Kit LAM, Kowloon (HK); Peter Han Joo CHONG, Kowloon (HK)

(73) Assignee: Zyetric Enterprise Limited, Kowloon (HK)

(21) Appl. No.: 16/636,307

(22) PCT Filed: Aug. 4, 2018
(86) PCT No.: PCT/IB2018/055880

§ 371 Date: Feb. 3, 2020

Related U.S. Application Data
(60) Provisional application No. 62/541,622, filed on Aug. 4, 2017.

(51) Int. Cl. G06T 19/00; G06K 9/00; G06K 9/46

(52) U.S. Cl. CPC G06T 19/006; G06K 9/4661; G06K 9/00664

(57) ABSTRACT

Systems and methods are directed to augmented reality (AR) environments where AR objects, such as intelligent virtual objects, interactively respond to ambient environmental changes. Image data are captured from one or more sensors, augmented reality environments are generated based on the image data, environmental parameters are detected from one or more environmental sensors, and views of the generated AR environment are displayed. Some views include the AR object existing therein, for instance when the detected environmental parameters satisfy certain criteria. Other views do not include the AR object while such criteria are not met.

### CROSS-REFERENCE TO RELATED APPLICATIONS

This application claims priority to U.S. Provisional Patent Application Ser. 62/541,622, entitled “INTELLIGENT VIRTUAL OBJECT IN AN AUGMENTED REALITY ENVIRONMENT INTERACTIVELY RESPONDING TO AMBIENT ENVIRONMENTAL CHANGES,” filed Aug. 4, 2017, the content of which is hereby incorporated by reference for all purposes.

### FIELD

The present disclosure relates to augmented reality (AR) environments and, more specifically, to interacting with AR environments.

### BACKGROUND

Virtual reality (VR) environments are entirely or mostly computer generated environments. While they may incorporate images or data from the real world, VR environments are computer generated based on the parameters and constraints set out for the environment. In contrast, augmented reality (AR) environments are largely based on data (e.g., image data) from the real world that is overlaid or combined with computer generated objects and events. Aspects of these technologies have been used separately using dedicated hardware.

### SUMMARY

Below, embodiments of inventions are described to allow for AR objects, such as intelligent virtual objects existing in an intelligent AR environment, to interactively respond to ambient environmental changes.

In some embodiments, at an electronic device having a display, one or more image sensors, and one or more environmental sensors, image data from the one or more image sensors are captured. An augmented reality (AR) environment based on the captured image data is generated. One or more environmental parameters from the one or more environmental sensors are detected. In accordance with a determination that the one or more environmental parameters meets a set of criteria, a view of the generated AR environment is displayed on the display. The view includes a computer-generated AR object at a position in the AR environment. In accordance with a determination that the one or more environmental parameters does not meet the set of criteria, a view of the generated AR environment is displayed without displaying the computer-generated AR object at the position in the AR environment.

Various examples of the present embodiments can be contemplated. For example, the one or more environmental sensors include a microphone, the one or more image sensors, a light sensor, a temperature sensor, or an air sensor. The one or more environmental parameters includes a first parameter corresponding to sound, light, temperature, or air quality. The set of criteria includes a criterion that is met when the one or more environmental parameters indicate a light level above a threshold amount of light. The set of criteria includes a criterion that is met when the one or more environmental parameters indicate a light level below a threshold amount of light. The set of criteria includes a criterion that is met when the one or more environmental parameters indicate sound above a threshold amount of sound or sound below a threshold amount of sound. The set of criteria includes a criterion that is met when the one or more environmental parameters indicate the presence of a person in the captured image data. The set of criteria includes a criterion that is met when the one or more environmental parameters indicate the presence of a predefined person in the captured image data. The set of criteria includes a criterion that is met when the one or more environmental parameters indicate the presence of a predefined object in the captured image data.

In some embodiments, an electronic device includes a display, one or more processors, memory, and one or more programs, wherein the one or more programs are stored in the memory and configured to be executed by the one or more processors. The one or more programs include instructions for performing any of the methods or steps described above and herein.

In some embodiments, a computer readable storage medium stores one or more programs, and the one or more programs include instructions, which when executed by an electronic device with a display, cause the device to perform any of the methods or steps described above and herein.

In some embodiments, an electronic device includes means for performing any of the methods or steps described above and herein.

### BRIEF DESCRIPTION OF THE FIGURES

The present application can be best understood by reference to the figures described below taken in conjunction with the accompanying drawing figures, in which like parts may be referred to by like numerals.

FIGS. 1A-1B depict an exemplary electronic device that implements various embodiments of the present invention.

FIG. 2 depicts an example AR environment with an example AR object, in accordance with various embodiments of the present invention.

FIG. 3 depicts a variation of the AR environment of FIG. 2 without the AR object, in accordance with various embodiments of the present invention.

FIG. 4 depicts another example AR environment with the example AR object, in accordance with various embodiments of the present invention.

FIG. 5 depicts a variation of the AR environment of FIG. 4 without the example AR object, in accordance with various embodiments of the present invention.

FIG. 6 depicts an example flow chart showing a process, in accordance with various embodiments of the present invention.

FIG. 7 depicts a system, such as a smart device, that may be used to implement various embodiments of the present invention.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

The following definitions are used to describe some embodiments of the invention below:

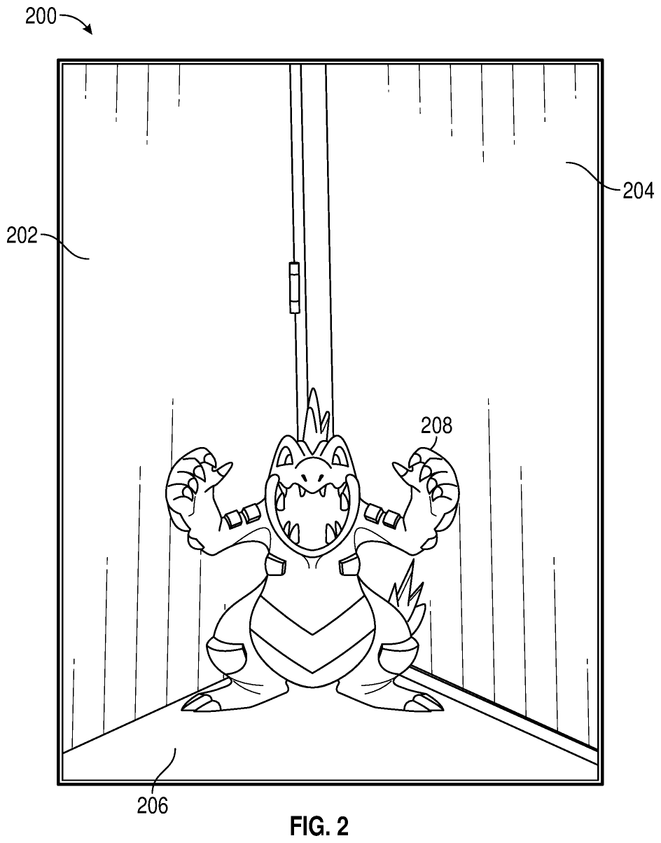

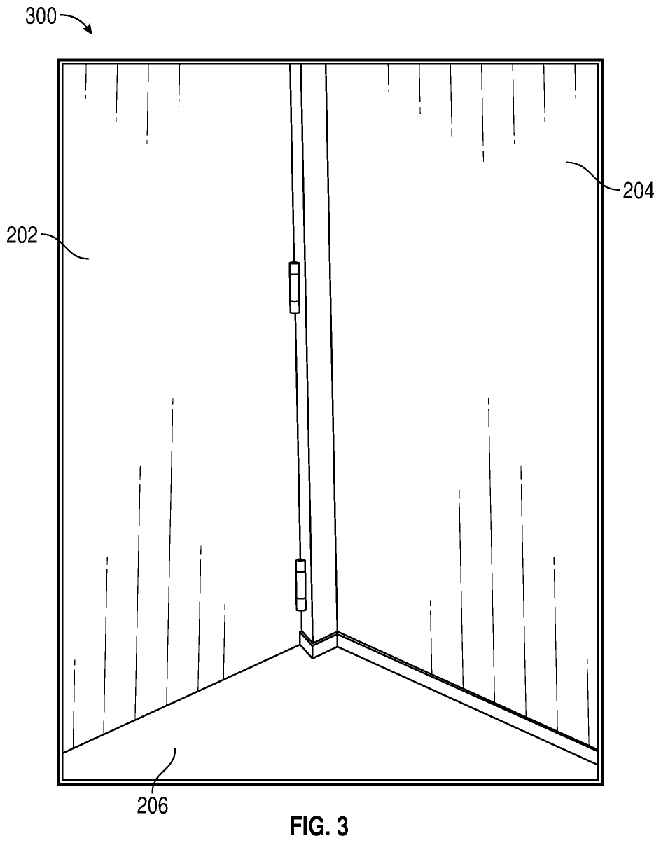

IAR Background—The real-time “background” view seen from the back-facing camera in some IAR games or applications. FIGS. 2 and 3 depict an example that includes a door 202, wall 204, and floor 206.

IAR Object—The computerized virtual object overlaid onto the IAR Background. FIG. 2 depicts an example monster 208.

IAR Gesture—A general term referring to a hand gesture or a series of hand gestures recognized by the back-facing camera or other sensors.

IAR View—The view or display of the combined IAR Background, IAR Object(s) and/or IAR Gesture(s). FIG. 2 depicts an example view 200.

The present disclosure provides various applications and enhancements for AR technology, such as intelligent augmented reality (“IAR”) which combines artificial intelligence (AI) with augmented reality (AR). An example AR environment includes a virtual object existing in a displayed, physical environment in a manner such that it can comprehend possible actions and interactions with users. In some embodiments, an AR environment is generated on a smart device and a determination is made regarding whether an IAR object should be overlaid onto an IAR background based on information about the physical environment. For example, lighting conditions of the physical environment surrounding the device may determine whether an AR monster is included in the generated AR environment and/or displayed in an IAR view. As another example, the presence of a person or object in image data of the physical environment may be used to determine whether an IAR object is present in the generated AR environment.

This technique is useful in many circumstances. For instance, in some AR games or applications, the virtual object is fully controlled by the central processing unit of the smart device and is sometimes capable of responding to user inputs such as hand gestures or even voice commands. Nonetheless, these virtual objects are only responding to the commands from the player, rather than intelligently making decisions solely based on the ambient environmental changes. Using embodiments of the present technology, another level of intelligence is added to virtual objects (e.g., IAR objects)—intelligence for the objects to respond to environmental changes such as ambient sound and/or light sources, and/or even people or objects in the environment—to improve the interactivity between the player and the objects.

As an example, in a monster shooting game, player P1 will score when the monster is shot. The monster is an IAR object running around the AR environment. Using gaming logic implementing embodiments of the current technology, the monster responds to the environmental changes in, for example, one or more of the following ways described herein.

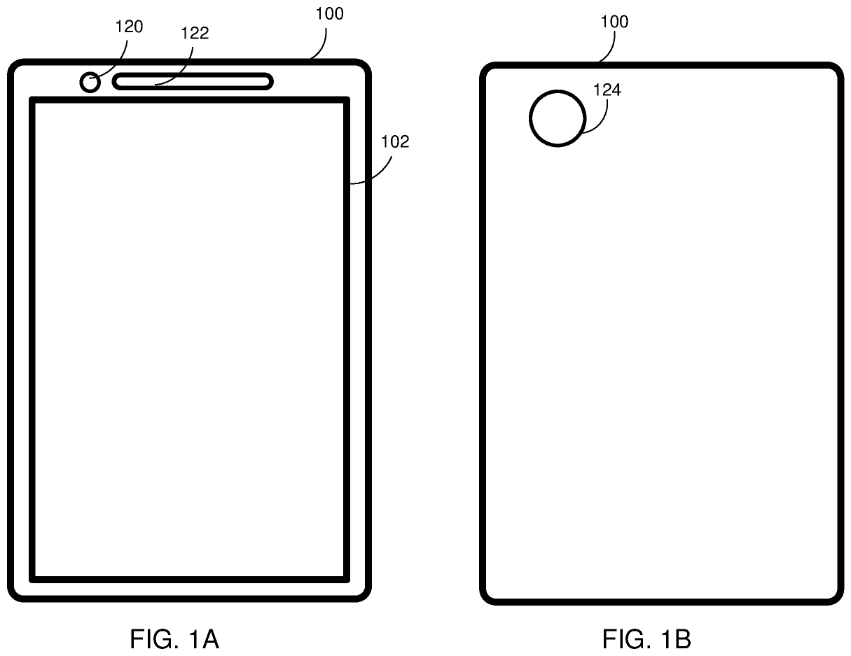

Referring to FIGS. 1A-1B, a front view and a back view, respectively, of smart device 100 which can be utilized to implement various embodiments of the present technology is shown. In some examples, smart device 100 is a smart phone or tablet computing device. However, it is noted that that the embodiments described herein are not limited to performance on a smart device, and can be implemented on other types of electronic devices, such as wearable devices, computers, or laptop computers.

As shown in FIG. 1A, a front side of the smart device 100 includes a display screen, such as a touch sensitive display 102, a speaker 122, and a front-facing camera 120. The touch-sensitive display 102 can detect user inputs received thereon, such as a number and/or location of finger contact(s) on the screen, contact duration, contact movement across the screen, contact coverage area, contact pressure, and so on. Such user inputs can generate various interactive effects and controls at the device 100. In some examples, the front-facing camera 120 faces the user and captures the user's movements, such as hand or facial gestures, which may be registered and analyzed as input for generating interactions during the augmented reality experiences described herein. The touch-sensitive display 102 and speaker 122 further promote user interaction with various programs at the device, such as by detecting user inputs while displaying visual effects on the display screen and/or while generating verbal communications or sound effects from the speaker 122.

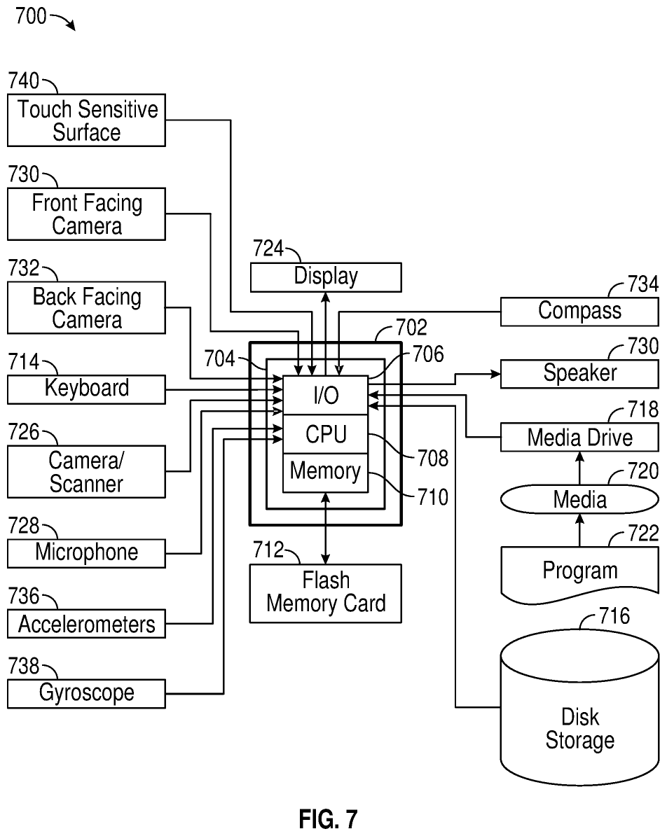

FIG. 1B shows an example back view of the smart device 100 having a back-facing camera 124. In some embodiments, the back-facing camera 124 captures images of an environment or surrounding, such as a room or location that the user is in or observing. In some examples, smart device 100 shows such captured image data as a background to an augmented reality experience displayed on the display screen. Optionally, smart device 100 includes a variety of other sensors and/or input mechanisms to receive user and environmental inputs, such as microphones (which is optionally integrated with speaker 122), movement/orientation sensors (e.g., one or more accelerometers, gyroscopes, digital compasses), depth sensors (which are optionally part of front-facing camera 120 and/or back-facing camera 124), and so on. In some examples, smart device 100 is similar to and includes some or all of the components of computing system 700 described below in FIG. 7. In some examples, the present technology is performed at a smart device having display screen 102 and back-facing camera 124.

The smart device described above can provide various augmented reality experiences, such as an example AR experience whereby a computer-generated object, such as an IAR object or intelligent virtual object, exists in an AR environment in a manner such that it interactively responds to ambient environmental changes and conditions. Merely by way of example, the IAR object can respond to ambient light. For instance, the IAR object is a monster that is only presented within the AR environment when the physical environment is dark. The monster escapes or disappears from the AR environment when it “sees” any ambient light from the environment, and reappears when the environment is dark enough. In other words, when the AR environment generation program disclosed herein detects a threshold amount of light (or brightness or light change) in the physical environment surrounding the smart device that runs the AR program, the program responds by removing, moving, relocating, or otherwise changing the IAR object based on the detected level of light. It is noted that any number of sensors (e.g., image sensors or photodiodes) can be used to implement this technique. For example, whenever the ambient light sensor detects any ambient light that is higher than a pre-set threshold for over a threshold period of time, an “escape” command for the IAR object is triggered in real-time or near-real time, causing IAR object to disappear from display. Similarly, when the ambient light sensor detects that the ambient light source is reduced to below the threshold level for a threshold period, an “appear” command for IAR object is triggered so that the object would appears or reappears in the AR environment.

FIGS. 2 and 3 depict an example of the IAR object responding to ambient light. The example augmented reality experience is provided at a display screen on an electronic device, such as at touch-sensitive display 102 on smart device 100 described above. As shown in FIG. 2, an IAR view 200 of a generated AR environment is displayed. IAR view 200 includes an IAR background having a door 202, wall 204, and floor 206. The IAR background may be generated (e.g., in real-time or near-real time) for display based on image data captured from an image sensor at the smart device 100. While displaying IAR view 200, an ambient level of light that is detected at a light sensor (e.g., as measured by a photo diode or an image sensor) of smart device 100 is determined to be below a threshold light level. In this particular example, the determination that the ambient light level is below the threshold light level corresponds to an environmental parameter (e.g., amount of ambient light) that satisfies a criterion (or a set of criteria) which causes or otherwise allows IAR object 208 (e.g., a monster) to be present in the AR environment and thus displayed in IAR view 200.

On the other hand, in FIG. 3, IAR view 300 is displayed having a similar or same IAR background as in FIG. 2, with door 202, wall 204, and floor 206, but the detected level of ambient light has surpassed the threshold light level. For example, the AR environment in FIG. 3 may correspond to a physical reality living room that is lighted and thus detected ambient light levels surpass the threshold level of light. Turning off the living room lights may lower the detected ambient light level below the threshold light level, causing the device 100 to generate the IAR view 200 of FIG. 2, in which the IAR object 208 reappears. Turning on the lights will transition IAR view 200 back to IAR view 300 if the detected ambient light level is above the threshold light level. In that case, the IAR object 108 disappears from the displayed AR environment. In some cases, while IAR object 108 disappears from display, the IAR object 108 continues to exist in the AR experience but is moved or hidden elsewhere in the AR environment.

Variations can be contemplated without departing from the spirit of the invention. For example, rather than displaying no IAR objects, a change in the environmental parameters can cause the displayed IAR object to transform to another shape, perform a predefined animation or sequence of actions, or exist in a different operating mode or personality. For example, the IAR object is displayed as a monster ready for attack when the ambient light level is below the threshold light level, and transforms to a small friendly creature when the ambient light level is above the threshold light level. Additionally and/or alternatively, the IAR object can provide different interactive effects or operating modes based on the detected environmental parameters.

Further, in some embodiments disclosed herein, an IAR object responds to other objects or people detected in the physical environment. For example, the monster would only be present in the AR environment when a certain other object or person is present or not present. The monster may escape or disappear from the AR environment when it “sees” some object or person walking by, and reappear when the pedestrian leaves the proximity. This can be implemented by detecting objects or people within a “live-view” captured by the back-facing camera (e.g., back-facing camera 124) of the smart device 100. In some examples, the back-facing camera 124 is turned on by default when the player starts an AR game. Therefore, whenever an object or person is detected within the “live-view” of the back-facing camera of a smart device, an “escape” command for IAR object is triggered. Similarly, when the object or person leaves the “live-view” of the back-facing camera 124, an “appear” command for the IAR object is triggered, so that the object would appear or reappear to the AR environment. In some examples, the device 100 distinguishes whether a detected object or person is associated with a predefined identity, such that only certain identified objects or persons in the live-view trigger the IAR object to appear or reappear.

Further, in some embodiments disclosed herein, an IAR object responds to other objects or people detected in the physical environment. For example, the monster would only be present in the AR environment when a hand gesture or a series of hand gestures is/are present or not present. The monster may escape or disappear from the AR environment when it “sees” the user making the hand gesture or a series of hand gestures in the real world. This can be implemented by detecting a hand gesture or a series of hand gestures within a “live-view” captured by the back-facing camera (e.g., back-facing camera 124) of the smart device 100.

In some examples, the back-facing camera 124 is turned on by default when the player starts an AR game. Therefore, whenever a hand gesture is detected within the “live-view” of the back-facing camera of a smart device, IAR gesture will be included in the AR environment. IAR view including IAR gesture in IAR background will be displayed on the touch sensitive display 102.

An “escape” command for IAR object is triggered. Similarly, when the hand gesture leaves the “live-view” of the back-facing camera 124, an “appear” command for the IAR object is triggered, so that the IAR object would appear or reappear to the AR environment. In some examples, the device 100 distinguishes whether a detected hand gesture is associated with a predefined hand gesture, such that only certain identified hand gestures in the live-view trigger the IAR object to appear or reappear.

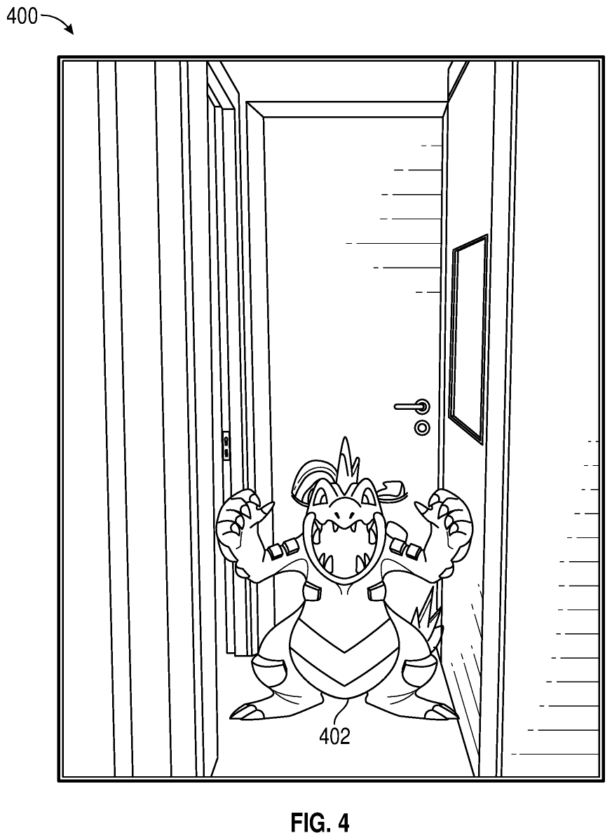

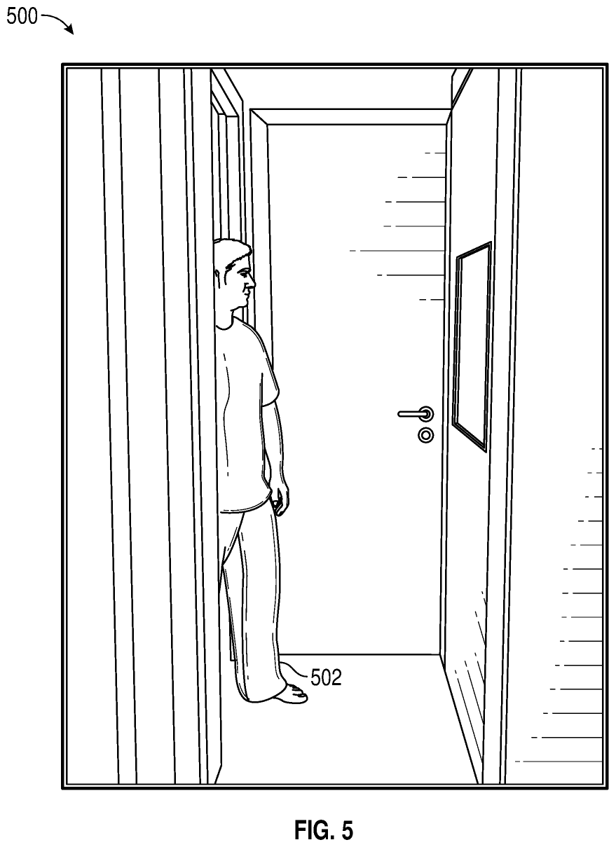

Turning now to FIGS. 4 and 5, the above technique is illustrated in an example AR experience, in accordance with various embodiments of the present invention. In FIG. 4, IAR view 400 is displayed, consisting of a generated AR environment that includes IAR background, such as a hallway without a person. The IAR background may be generated from captured image data from an image sensor of the smart device 100, such as back-facing camera 124. In IAR view 400, no person or other predefined object is present, so IAR object 402 (e.g., a monster) is present in the AR environment and displayed in IAR view 400. On the other hand, in FIG. 5, IAR view 500 is displayed with person 502. In response, the previously-displayed IAR object 402 is no longer shown in the AR environment (or has at least been moved someplace else in the AR environment) and is not displayed in IAR view 500.

As a further example, in some embodiments the IAR object responds to ambient sound. For example, the monster is only present in the AR environment in a quiet physical environment. The monster may escape or disappear from the AR environment when it “hears” any ambient sound from the environment, and reappear when the environment is quiet enough. In other words, when the AR environment generation program detects a threshold amount of sound in the physical environment around the smart device running the AR program, the program removes, moves, relocates, or otherwise changes the IAR object in response to the sound. The microphone of the smart device 100 can be used for this purpose. In some examples, at the start of the game, the microphone is turned on automatically. For example, whenever a determination is made that the microphone is detecting an ambient sound level that is higher than a pre-set threshold sound level, and/or the optionally exceeds a threshold period of time, an “escape” command for the IAR object is triggered. Similarly, when a determination is made that the microphone is detecting that the ambient sound source is reduced to below the threshold level for a threshold period, an ‘appear” command for the IAR object is triggered so that the object would appear/reappear to the AR environment. In some examples, the device 100 identifies or otherwise listens for certain types of sounds or verbal commands, and/or specific threshold decibel levels that are predefined to be associated with such sounds or verbal commands, and generates a response from the IAR object accordingly. In some examples, the device 100 implements different threshold sound levels based on other environmental conditions. For example, when the detected ambient light level is above a threshold level (lights are on), the threshold sound level may be higher than a corresponding threshold sound level that is implemented when the detected ambient light level is below a threshold level (lights are off). Merely by way of illustration, in such cases, the monster is more easily scared during the game when the physical environment is dark versus when there is sufficient light.

In other embodiments, similar techniques can be applied to many other environmental changes when the corresponding sensors are available to the smart device. For example, smoke, smell, facial recognition, etc., can trigger a response from the IAR object. A variety of responses by the IAR object can be contemplated, such as escaping, reappearing, disappearing, transforming, performing other actions or moods, and so on. Further in some examples, certain combinations of environmental parameters can be detected and when determined to satisfy certain sets of criteria, specific responses in the IAR object may be provided. For example, in response to detecting that an ambient sound level is above a threshold sound level while simultaneously detecting that a predefined object or person is present in the live-view, the IAR object may respond by mimicking a “spooked” state, whereby a verbal or sound effect (e.g., a scream) may be generated by speaker 122 while the IAR object is animated to jump or run away. The IAR object may reappear after a predetermined period of time has passed or in response to other changes detected in the environment. Therefore, the above examples are non-limiting and are presented for ease of explanation.

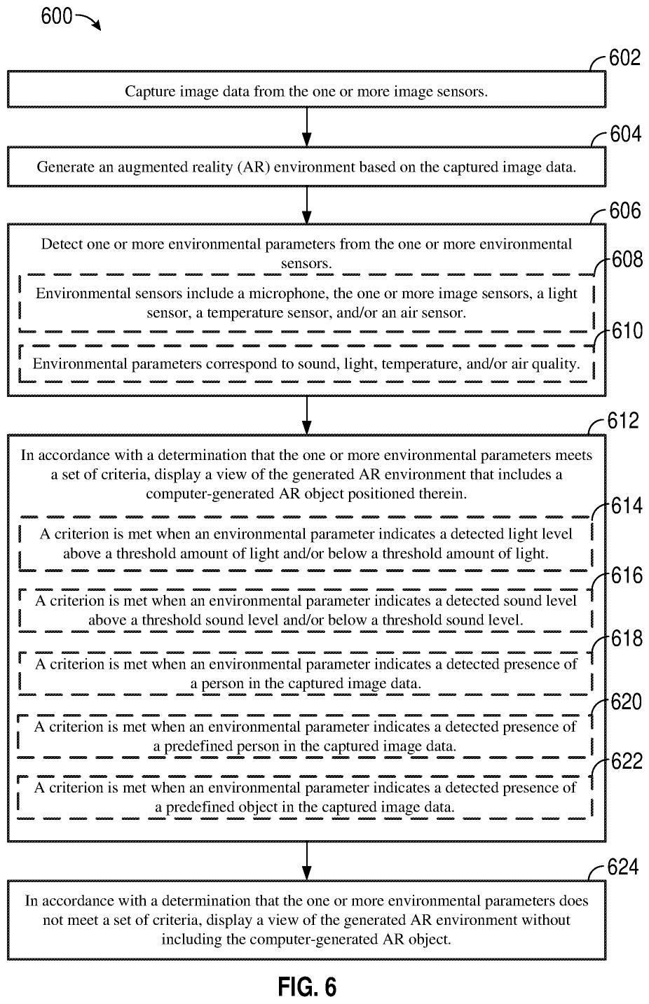

Turning now to FIG. 6, an example process 600 is shown for providing an intelligent virtual object in an augmented reality environment, whereby the intelligent virtual object and/or the augmented reality environment interactively responds to ambient environmental changes. In some examples, the process 600 is implemented at an electronic device (e.g., smart device 100) having a display, one or more image sensors, and/or one or more environmental sensors. In some examples, the process 600 is implemented as the AR environment generation program described above.

As shown in FIG. 6, process 600 includes capturing image data from the one or more image sensors (block 602).

Process 600 includes generating an augmented reality (AR) environment based on the captured image data (block 604).

Process 600 includes detecting one or more environmental parameters from the one or more environmental sensors (block 606). In some examples, the one or more environmental sensors include a microphone, the one or more image sensors, a light sensor, a temperature sensor, or an air sensor (block 608). These sensors detect characteristics of the area surrounding the smart device (or other device). In some examples, the one or more environmental parameters includes a first parameter corresponding to sound, light, temperature, or air quality (block 610).

Process 600 can include determining whether the one or more environmental parameters meets a set of criteria. Process 600 includes, in accordance with a determination that the one or more environmental parameters meets a set of criteria, displaying, on the display, a view of the generated AR environment, wherein the view includes a computer-generated AR object at a position in the AR environment (block 612). Optionally, the set of criteria includes a criterion that is met when the one or more environmental parameters indicate a detected light level above a threshold amount of light or light level, and/or the set of criteria includes a criterion that is met when the one or more environmental parameters indicate a light level below a threshold amount of light or light level (block 614). In some examples, the set of criteria includes a criterion that is met when the one or more environmental parameters indicate sound or a detected sound level that is above a threshold amount of sound or sound level, and/or below a threshold amount of sound or sound level (block 616). In some examples, the set of criteria includes a criterion that is met when the one or more environmental parameters indicate the presence of a person in the captured image data (block 618). In some examples, the set of criteria includes a criterion that is met when the one or more environmental parameters indicate the presence of a predefined person in the captured image data (block 620). Still, in some examples, the set of criteria includes a criterion that is met when the one or more environmental parameters indicate the presence of a predefined object in the captured image data (block 622).

Process 600 includes, in accordance with a determination that the one or more environmental parameters does not meet the set of criteria, displaying, on the display, a view of the generated AR environment without displaying the computer-generated AR object at the position in the AR environment (block 624).

In some cases, process 600 repeats until end (e.g., game end or user otherwise terminates the process). In such cases, process 600 may continuously detect for one of more environmental parameters (block 606) and update the display with views of the AR environment with or without AR objects in accordance with the methods and steps described above (e.g., blocks 612-624).

Turning now to FIG. 7, components of an exemplary computing system 700, configured to perform any of the above-described processes and/or operations are depicted. For example, computing system 700 may be used to implement the smart device 100 described above that implements any combination of the above embodiments or process 600 described with respect to FIG. 6. Computing system 700 may include, for example, a processor, memory, storage, and input/output peripherals (e.g., display, keyboard, stylus, drawing device, disk drive, Internet connection, camera/scanner, microphone, speaker, etc.). However, computing system 700 may include circuitry or other specialized hardware for carrying out some or all aspects of the processes.

In computing system 700, the main system 702 may include a motherboard 704, such as a printed circuit board with components mount thereon, with a bus that connects an input/output (I/O) section 706, one or more microprocessors 708, and a memory section 710, which may have a flash memory card 712 related to it. Memory section 710 may contain computer-executable instructions and/or data for carrying any of the techniques and processes described herein. The I/O section 706 may be connected to display 724 (e.g., to display a view), a touch sensitive surface 740 (to receive touch input and which may be combined with the display in some cases), a keyboard 714 (e.g., to provide text), a camera/scanner 726, a microphone 728 (e.g., to obtain an audio recording), a speaker 730 (e.g., to play back the audio recording), a disk storage unit 716, and a media drive unit 718. The media drive unit 720 can read/write a non-transitory computer-readable storage medium 720, which can contain programs 722 and/or data used to implement process 600 and any of the other processes described herein. Computing system 700 also includes one or more wireless or wired communication interfaces for communicating over data networks.

Additionally, a non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++, Java, or the like) or some specialized application-specific language.

Computing system 700 may include various sensors, such as front facing camera 730 and back facing camera 732. These cameras can be configured to capture various types of light, such as visible light, infrared light, and/or ultra violet light. Additionally, the cameras may be configured to capture or generate depth information based on the light they receive. In some cases, depth information may be generated from a sensor different from the cameras but may nonetheless be combined or integrated with image data from the cameras. Other sensors included in computing system 700 include a digital compass 734, accelerometer 736, gyroscope 738, and/or the touch-sensitive surface 740. Other sensors and/or output devices (such as dot projectors, IR sensors, photo diode sensors, time-of-flight sensors, haptic feedback engines, etc.) may also be included.

While the various components of computing system 700 are depicted as separate in FIG. 7, various components may be combined together. For example, display 724 and touch sensitive surface 740 may be combined together into a touch-sensitive display.

Exemplary methods, non-transitory computer-readable storage media, systems, and electronic devices are set out in example implementations of the following items:

Item 1. A method comprising:

at an electronic device having a display, one or more image sensors, and one or more environmental sensors:
capturing image data from the one or more image sensors;
generating an augmented reality (AR) environment based on the captured image data;
detecting one or more environmental parameters from the one or more environmental sensors;
in accordance with a determination that the one or more environmental parameters meets a set of criteria, displaying, on the display, a view of the generated AR environment, wherein the view includes a computer-generated AR object at a position in the AR environment; and
in accordance with a determination that the one or more environmental parameters does not meet the set of criteria, displaying, on the display, a view of the generated AR environment without displaying the computer-generated AR object at the position in the AR environment.

Item 2. The method of item 1, wherein the one or more environmental sensors include a microphone, the one or more image sensors, a light sensor, a temperature sensor, or an air sensor.

Item 3. The method of item 1 or item 2, wherein the one or more environmental parameters includes a first parameter corresponding to sound, light, temperature, or air quality.

Item 4. The method of any one of items 1-3, wherein the set of criteria includes a criterion that is met when the one or more environmental parameters indicate a light level above a threshold amount of light.

Item 5. The method of any one of items 1-4, wherein the set of criteria includes a criterion that is met when the one or more environmental parameters indicate a light level below a threshold amount of light.

Item 6. The method of any one of items 1-5, wherein the set of criteria includes a criterion that is met when the one or more environmental parameters indicate sound above a threshold amount of sound or sound below a threshold amount of sound.

Item 7. The method of any one of items 1-6, wherein the set of criteria includes a criterion that is met when the one or more environmental parameters indicate the presence of a person in the captured image data.

Item 8. The method of any one of items 1-7, wherein the set of criteria includes a criterion that is met when the one or more environmental parameters indicate the presence of a predefined person in the captured image data.

Item 9. The method of any one of items 1-8, wherein the set of criteria includes a criterion that is met when the one or more environmental parameters indicate the presence of a predefined object in the captured image data.

Item 10. An electronic device, comprising:

a display;

one or more processors;

memory; and

one or more programs, wherein the one or more programs are stored in the memory and configured to be executed by the one or more processors, the one or more programs including instructions for performing any of the methods of items 1-9.

Item 11. A computer readable storage medium storing one or more programs, the one or more programs comprising instructions, which when executed by an electronic device with a display, cause the device to perform any of the methods of items 1-9.

Item 12. An electronic device, comprising:

means for performing any of the methods of items 1-9.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features which may be readily separated from or combined with the features of any of the other several embodiments without departing from the scope or spirit of the various embodiments.

1. A method comprising:
at an electronic device having a display, one or more image sensors, and one or more environmental sensors:
capturing image data from the one or more image sensors;
generating an augmented reality (AR) environment based on the captured image data;
detecting one or more environmental parameters from the one or more environmental sensors;
in accordance with a determination that the one or more environmental parameters meets a set of criteria, displaying, on the display, a view of the generated AR environment, wherein the view includes a computer-generated AR object at a position in the AR environment; and
in accordance with a determination that the one or more environmental parameters does not meet the set of criteria, displaying, on the display, a view of the generated AR environment without displaying the computer-generated AR object at the position in the AR environment.

2. The method of claim 1, wherein the one or more environmental sensors include a microphone, the one or more image sensors, a light sensor, a temperature sensor, or an air sensor.

3. The method of claim 1, wherein the one or more environmental parameters includes a first parameter corresponding to sound, light, temperature, or air quality.

4. The method of claim 1, wherein the set of criteria includes a criterion that is met when the one or more environmental parameters indicate a light level above a threshold amount of light.

5. The method of claim 1, wherein the set of criteria includes a criterion that is met when the one or more environmental parameters indicate a light level below a threshold amount of light.

6. The method of claim 1, wherein the set of criteria includes a criterion that is met when the one or more environmental parameters indicate sound above a threshold amount of sound or sound below a threshold amount of sound.

7. The method of claim 1, wherein the set of criteria includes a criterion that is met when the one or more environmental parameters indicate the presence of a person in the captured image data.

8. The method of claim 1, wherein the set of criteria includes a criterion that is met when the one or more environmental parameters indicate the presence of a predefined person in the captured image data.

9. The method of claim 1, wherein the set of criteria includes a criterion that is met when the one or more environmental parameters indicate the presence of a predefined object in the captured image data.

10. An electronic device, comprising:
a display;
one or more image sensors;
one or more environmental sensors;
one or more processors;
memory; and
one or more programs, wherein the one or more programs are stored in the memory and configured to be executed by the one or more processors, the one or more programs including instructions for:
capturing image data from the one or more image sensors;
generating an augmented reality (AR) environment based on the captured image data;
detecting one or more environmental parameters from the one or more environmental sensors;
in accordance with a determination that the one or more environmental parameters meets a set of criteria, displaying, on the display, a view of the generated AR environment, wherein the view includes a computer-generated AR object at a position in the AR environment; and
in accordance with a determination that the one or more environmental parameters does not meet the set of criteria, displaying, on the display, a view of the generated AR environment without displaying the computer-generated AR object at the position in the AR environment.

11. A computer readable storage medium storing one or more programs, the one or more programs comprising instructions, which when executed by an electronic device with a display, one or more image sensors, and one or more environmental sensors, cause the device to:
capture image data from the one or more image sensors;
generate an augmented reality (AR) environment based on the captured image data;
detect one or more environmental parameters from the one or more environmental sensors;
in accordance with a determination that the one or more environmental parameters meets a set of criteria, display, on the display, a view of the generated AR environment, wherein the view includes a computer-generated AR object at a position in the AR environment; and
in accordance with a determination that the one or more environmental parameters does not meet the set of criteria, display, on the display, a view of the generated AR environment without displaying the computer-generated AR object at the position in the AR environment.

12. (canceled)
